(19) United States
(12) Patent Application Publication
(10) Pub. No.: US 2026/0245459 A1
(43) Pub. Date: Aug. 20, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventor: Yasuhiko OCHIAI, Tokyo (JP)

(73) Assignee: NEC Corporation, Tokyo (JP)

(21) Appl. No.: 19/162,092

(22) PCT Filed: Mar. 16, 2023
(86) PCT No.: PCT/JP2023/010272

§ 371 Date: Sep. 4, 2025

(51) Int. Cl. G08G 1/16; G06T 7/20; G06V 20/54; G08G 1/01; G08G 1/04; G08G 1/052; G08G 1/0967

(52) U.S. Cl. CPC G08G 1/166; G06T 7/20; G06V 20/54; G08G 1/0133; G08G 1/04; G08G 1/052; G08G 1/096708; G08G 1/096766; G06T 2207/30236; G06V 2201/08

(57) ABSTRACT

The emergency vehicle detection device comprises: a determination means that, on the basis of features of a vehicle traveling on a road and relative movements between said vehicle and circumjacent vehicles, makes a determination as to whether or not said vehicle is an emergency vehicle traveling in response to an emergency; and a transmission means that transmits a result of said determination to a prescribed management terminal.

### TECHNICAL FIELD

The present invention relates to an information processing apparatus, an information processing method, and a recording medium.

### BACKGROUND ART

PTL 1 discloses a vehicle control device that sets a speed upper limit distribution defining an upper limit of a relative speed between the own vehicle and a stopped vehicle according to a starting possibility of the stopped vehicle when the own vehicle overtakes or passes the stopped vehicle. Specifically, in a case where the starting possibility is low, the vehicle control device disclosed in PTL 1 sets a speed upper limit, which is an upper limit of the relative speed of the target vehicle, to be large. On the other hand, in a case where the starting possibility is high, the speed upper limit is set to be small, and when overtaking a target vehicle with a high starting possibility, the own vehicle is controlled to overtake the target vehicle at a low speed. In PTL 1, it is described that the starting possibility is evaluated by communication with the target vehicle, the position of the driving range, the operation of the brake, the blinker, the presence or absence of the passenger, the open/close state of the door, and the like.

### CITATION LIST

### Patent Literature

PTL 1: JP 2019-142428 A

### SUMMARY OF INVENTION

### Technical Problem

As one of the methods for accurately evaluating the starting possibility, it is conceivable to communicate with the target vehicle and acquire the state of the vehicle as in PTL 1, but there is a problem that the vehicle control device cannot perform the function unless the target vehicle has a communication function. In a case where the starting possibility is evaluated only based on the appearance state of the target vehicle, such as the lighting state of the brake lamp, the blinker, the presence or absence of the passenger, and the open/close state of the door, regardless of the communication with the target vehicle, there is a possibility that erroneous determination occurs.

An object of the present disclosure is to provide an information processing apparatus, an information processing method, and a recording medium capable of accurately providing information indicating whether a vehicle on a road can be overtaken to another vehicle.

### Solution to Problem

According to a first aspect, there is provided an information processing apparatus including a detection means for detecting a first vehicle on a road, an identification means for identifying a movement of a second vehicle coming from behind the first vehicle from an image captured by a camera capable of imaging the road, a calculation means for calculating a degree of possibility for safely overtaking the first vehicle based on whether the second vehicle has overtaken the first vehicle, and an output means for outputting information indicating a degree of possibility for safely overtaking the first vehicle to a predetermined output destination.

According to a second aspect, there is provided an information processing method including detecting a first vehicle on a road, identifying a movement of a second vehicle coming from behind the first vehicle from an image captured by a camera capable of imaging the road, calculating a degree of possibility for safely overtaking the first vehicle based on whether the second vehicle has overtaken the first vehicle, and outputting information indicating a degree of possibility for safely overtaking the first vehicle to a predetermined output destination.

According to a third aspect, there is provided a recording medium that stores a program for executing processing of detecting a first vehicle on a road, processing of identifying a movement of a second vehicle coming from behind the first vehicle from an image captured by a camera capable of imaging the road, processing of calculating a degree of possibility for safely overtaking the first vehicle based on whether the second vehicle has overtaken the first vehicle, and processing of outputting information indicating a degree of possibility for safely overtaking the first vehicle to a predetermined output destination.

### Advantageous Effects of Invention

According to the present disclosure, it is possible to accurately provide information indicating whether a vehicle on a road can be overtaken to another vehicle.

### BRIEF DESCRIPTION OF DRAWINGS

FIG. 1 is a diagram illustrating a configuration according to an example embodiment of the present disclosure.

FIG. 2 is a flowchart illustrating an operation according to the example embodiment of the present disclosure.

FIG. 3 is a diagram illustrating an operation according to the example embodiment of the present disclosure.

FIG. 4 is a diagram illustrating an operation according to the example embodiment of the present disclosure.

FIG. 5 is a diagram illustrating an operation according to the example embodiment of the present disclosure.

FIG. 6 is a diagram illustrating a configuration according to a first example embodiment of the present disclosure.

FIG. 7 is a diagram illustrating an example of a table held by an information processing apparatus according to the first example embodiment of the present disclosure.

FIG. 8 is a flowchart illustrating an operation according to the first example embodiment of the present disclosure.

FIG. 9 is a diagram illustrating an operation according to the first example embodiment of the present disclosure.

FIG. 10 is a diagram illustrating a configuration according to a second example embodiment of the present disclosure.

FIG. 11 is a flowchart illustrating an operation according to the second example embodiment of the present disclosure.

FIG. 12 is a diagram illustrating an operation according to the second example embodiment of the present disclosure.

FIG. 13 is another diagram illustrating an operation according to the second example embodiment of the present disclosure.

FIG. 14 is still another diagram illustrating an operation according to the second example embodiment of the present disclosure.

FIG. 15 is still another diagram illustrating an operation according to the second example embodiment of the present disclosure.

FIG. 16 is a diagram illustrating a configuration according to a third example embodiment of the present disclosure.

FIG. 17 is a flowchart illustrating an operation according to the third example embodiment of the present disclosure.

FIG. 18 is a diagram illustrating an operation according to the third example embodiment of the present disclosure.

FIG. 19 is a diagram illustrating a configuration of a computer configuring an information processing apparatus of the present disclosure.

### EXAMPLE EMBODIMENT

First, an outline of example embodiments of the present disclosure will be described with reference to the drawings. Reference numerals assigned in the drawings of the outline are assigned to each element for convenience as an example for the sake of convenience to facilitate understanding, and are not intended to limit the present disclosure to any mode shown in drawings. An individual connection line between blocks in the drawings and the like referred to in the following description includes both bidirectional and unidirectional. A unidirectional arrow schematically indicates a flow of a principal signal (data), and does not exclude bidirectionality. A program is executed by a computer apparatus, and the computer apparatus includes, for example, a processor, a storage device, an input device, a communication interface, and a display device as necessary. The computer apparatus is configured to be communicable with devices (including a computer) inside or outside the device via a communication interface in a wired or wireless manner. Although there are ports and interfaces at connection points of input and output of each block in the relevant drawings, illustration of the port or interface is omitted.

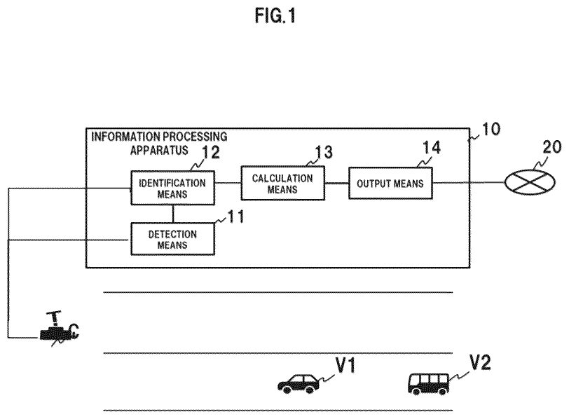

As illustrated in FIG. 1, an example embodiment of the present disclosure can be implemented by an information processing apparatus 10 including a detection means 11, an identification means 12, a calculation means 13, and an output means 14.

More specifically, the detection means 11 detects a first vehicle on a road, for example, the first vehicle located on the roadside of the road. The identification means 12 identifies the movement of a second vehicle coming from behind the first vehicle from an image captured by a camera capable of imaging the road. The calculation means 13 calculates a degree of possibility for safely overtaking the first vehicle. The output means 14 outputs information indicating a degree of possibility for safely overtaking the first vehicle to a predetermined output destination. For example, by outputting the information to a predetermined output destination on a network 20, the output means 14 can notify the high degree of possibility for safely overtaking the first vehicle. The calculation means 13 may calculate a possibility that the first vehicle is a “stopped vehicle” as an example of the degree of possibility for safely overtaking the first vehicle. At this time, the “stopped vehicle” refers to a state in which the first vehicle is stopped at the same location for a certain period of time, and includes a stopped state that is shorter in duration than “parking” as defined under the Road Traffic Act.

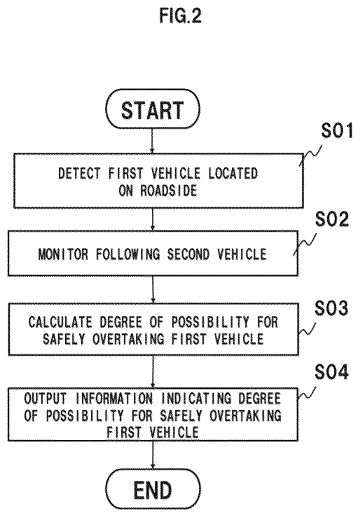

The information processing apparatus 10 configured as described above operates as follows. First, the information processing apparatus 10 detects the first vehicle located on the roadside (step S01 in FIG. 2). Being located on the roadside refers to a state in which the center line in the traveling direction of the vehicle is closer to the edge side relative to the center of the lane, and the vehicle may not necessarily be stopped.

Next, the information processing apparatus 10 monitors the second vehicle coming from behind the first vehicle using a camera C and identifies the movement of the second vehicle (step S02 in FIG. 2). At this time, the information processing apparatus 10 can be configured to identify the movement of the second vehicle coming from behind the first vehicle with reference to an image captured after the image in which the first vehicle is detected.

Next, the information processing apparatus 10 calculates a degree of possibility for safely overtaking the first vehicle based on whether the second vehicle has overtaken the first vehicle (step S03 in FIG. 2).

Finally, the information processing apparatus 10 outputs information indicating the degree of possibility for safely overtaking the first vehicle to a predetermined output destination (step S04 in FIG. 2).

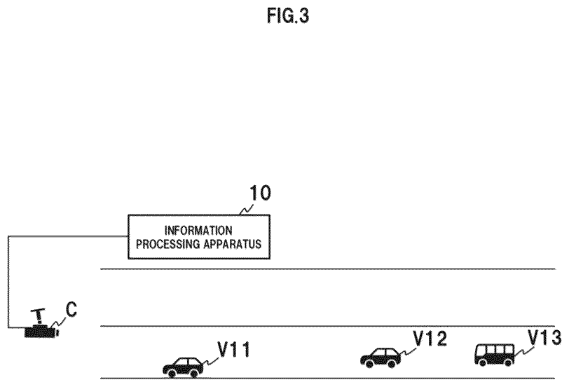

FIGS. 3 to 5 are diagrams illustrating operations according to the example embodiment of the present disclosure. In the example of FIG. 3, a vehicle V11 is located on the roadside. The vehicle V11 is referred to as a “first vehicle”. It is assumed that vehicles V12 and V13 follow behind the vehicle V11.

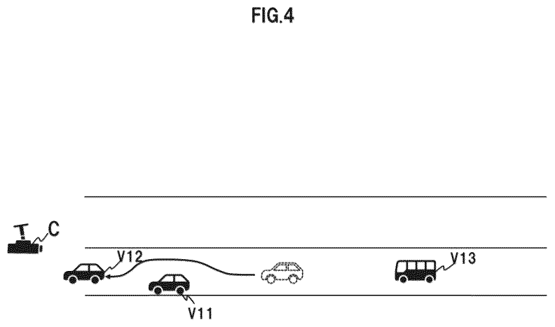

As illustrated in FIG. 4, the vehicle V12 overtakes the vehicle V11. In this case, the information processing apparatus 10 identifies that the second vehicle V12 coming from behind the first vehicle V11 overtakes the first vehicle V11, and calculates a degree of possibility for safely overtaking the first vehicle V11 based on this. Specifically, the information processing apparatus 10 calculates a high degree of possibility for safely overtaking the first vehicle V11 based on the fact that the second vehicle V12 has overtaken the first vehicle V11. The information processing apparatus 10 outputs a calculation result to a predetermined output destination. For example, by transmitting this calculation result to the vehicle V13, the vehicle V13 can recognize that the degree of possibility for safely overtaking the vehicle V11 is high, and can prepare for the overtaking operation or the like.

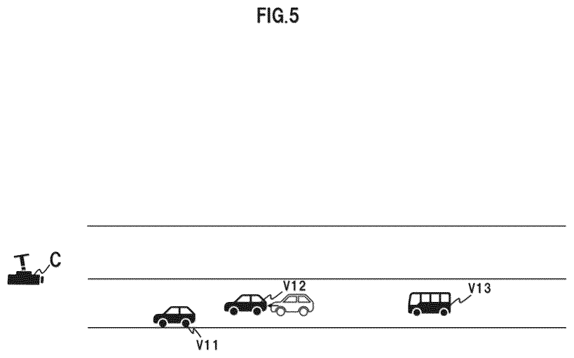

On the other hand, as illustrated in FIG. 5, it is assumed that the vehicle V12 decelerates and stops in front of the vehicle V11. In this case, the information processing apparatus 10 identifies that the second vehicle V12 coming from behind the first vehicle V11 does not overtake the first vehicle V11, and calculates a degree of possibility for safely overtaking the first vehicle V11 based on this. Specifically, the information processing apparatus 10 calculates a low degree of possibility for safely overtaking the first vehicle V11 based on the fact that the second vehicle V12 does not overtake the first vehicle V11. The information processing apparatus 10 outputs a calculation result to a predetermined output destination. For example, by transmitting this calculation result to the vehicle V13, the vehicle V13 can recognize that the degree of possibility for safely overtaking the first vehicle V11 is low, and can perform deceleration similar to that of the second vehicle V12.

As described above, according to the present example embodiment, it is possible to transmit, to another vehicle, a possibility that the first vehicle V11 on the road is a stopped vehicle.

### First Example Embodiment

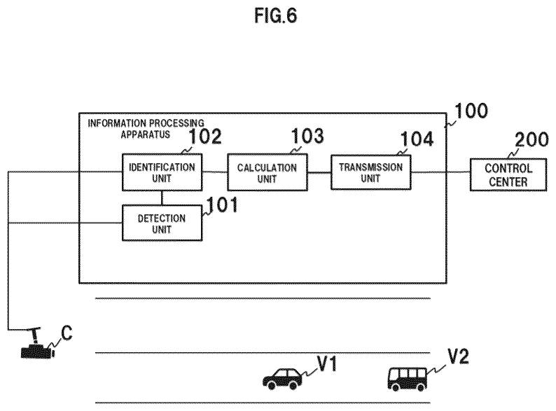

Next, a first example embodiment in which support is provided in such a way that a route bus can safely overtake a vehicle ahead in a path of the route bus will be described in detail with reference to the drawings. FIG. 6 is a diagram illustrating a configuration of the first example embodiment of the present disclosure. Referring to FIG. 6, an information processing apparatus 100 that is connected to a control center 200 and performs operation support for a route bus V2 by providing appropriate guidance to a vehicle V1 and the like is illustrated.

The information processing apparatus 100 includes a detection unit 101, an identification unit 102, a calculation unit 103, and a transmission unit 104.

The detection unit 101 detects the first vehicle (for example, the vehicle V11 in FIG. 3) located on the roadside of the road. In addition to a method for recognizing a vehicle as an object by using an image from the camera C, the detection unit 101 can also employ a method for detecting an obstacle such as a vehicle by installing an infrared or laser transceiver on the roadside of the road. It is also possible to employ a method for detecting a vehicle located on the roadside from information acquired by a radar, LiDAR, a detector embedded in a road surface, or the like. As a reference for being located on the roadside of the road, for example, a reference in which a distance between the roadside of the road and the vehicle body is within a predetermined threshold, a reference in which the vehicle body is located on a road shoulder, or the like can be used. The detection unit 101 corresponds to the detection means 11 described above.

The identification unit 102 monitors a following vehicle coming from behind the first vehicle and identifies the movement of the following vehicle from an image captured by the camera C capable of imaging the road. The image captured by the camera C is an image captured after a time point at which the first vehicle is detected. The camera C in the present disclosure is not limited to a visible image camera. For example, LiDAR or a camera that captures an infrared image can be used. The identification unit 102 corresponds to the identification means 12 described above. The identification unit 102 may continue the operation of monitoring the following vehicle for a predetermined time, and the number of following vehicles may be plural.

The calculation unit 103 calculates a value indicating a degree of possibility for safely overtaking the first vehicle based on whether the following vehicle (second vehicle, for example, the vehicle V12 in FIGS. 4 and 5) has overtaken the first vehicle. In the present example embodiment, the calculation unit 103 calculates a score indicating a degree of possibility for safely overtaking the first vehicle. The calculation unit 103 corresponds to the calculation means 13 described above. The calculation unit 103 may calculate a score in such a way that the score becomes higher according to the number of second vehicles that have overtaken the first vehicle V11.

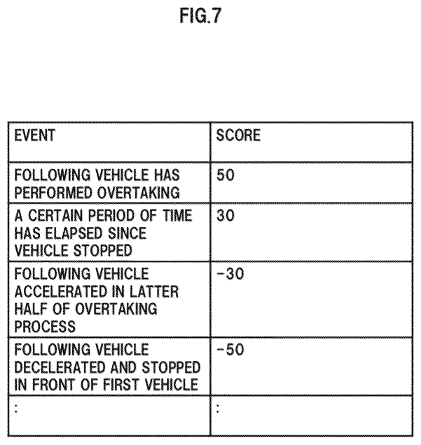

FIG. 7 is a diagram illustrating an example of a table held by the information processing apparatus 100 according to the first example embodiment of the present disclosure. When detecting the occurrence of a certain event, the information processing apparatus 100 according to the present example embodiment adds the score. For example, in a case where the second vehicle (for example, the vehicle V12 in FIGS. 4 and 5) has overtaken the first vehicle (for example, the vehicle V11 in FIGS. 4 and 5), the information processing apparatus 100 adds 50 points as the score. For example, in a case where a certain period of time has elapsed since the first vehicle (for example, the vehicle V11 in FIGS. 4 and 5) was detected, and in a case where a predetermined period of time has elapsed since the first vehicle stopped, the information processing apparatus 100 performs correction by adding 30 points as the score.

When detecting the occurrence of a certain event, the information processing apparatus 100 subtracts the score. In the example of FIG. 7, in a case where the second vehicle (for example, the vehicle V12 in FIGS. 4 and 5) accelerates in the latter half of the overtaking process, the information processing apparatus 100 performs correction by subtracting 30 points from the score. In a case where the second vehicle (for example, the vehicle V12 in FIGS. 4 and 5) decelerates and stops in front of the first vehicle (for example, the vehicle V11 in FIGS. 4 and 5), the information processing apparatus 100 performs correction for subtracting 50 points from the score. As described above, the information processing apparatus 100 calculates a score indicating a degree of possibility for safely overtaking the first vehicle.

Although only the behavior of the second vehicle (for example, the vehicle V12 in FIGS. 4 and 5) is described in the example of FIG. 7, the score may be added or subtracted using information obtained from the image of the first vehicle. For example, in a case where it is determined that the first vehicle is turning on a hazard lamp, the passenger is getting on and off by opening the door, the driver's seat is vacant, or the like, the score may be added. Conversely, for example, in a case where it is determined that the first vehicle is turning on a brake lamp, turning on the blinker, a person is in the driver's seat, or the like, the score may be subtracted. In the above-described example, the score is calculated by addition and subtraction, but a method for calculating the score by multiplying by a correction factor according to the event type or the like can also be employed. The score can also be calculated by an evaluation formula using both addition and subtraction.

The transmission unit 104 transmits the calculation result to the control center 200.

The control center 200 provides operation support for the route bus V2 by using the scores received from the information processing apparatus 100. Various forms are conceivable as this operation support. For example, the control center 200 transmits, to the route bus V2 approaching the first vehicle from behind the first vehicle, a score indicating a degree of possibility for safely overtaking the vehicle (first vehicle) ahead. The route bus V2 can display this score on an in-vehicle terminal. In a case where the route bus V2 is a self-driving vehicle, the route bus V2 can determine whether to overtake the first vehicle, and adjust the speed at the time of overtaking the first vehicle and a distance between the first vehicle and the route bus V2, by using this score.

In a case where the control center 200 has a function of directly controlling the route bus V2, this score may be used to directly control (remotely control) the route bus V2. For example, when remotely controlling the route bus V2, the control center 200 performs driving using this score. As described above, the transmission unit 104 corresponds to the above-described output means 14.

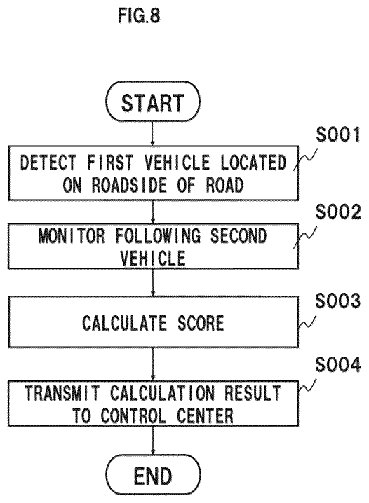

Next, the operation of the present example embodiment will be described in detail with reference to the drawings. FIG. 8 is a flowchart illustrating the operation according to the first example embodiment. Referring to FIG. 8, first, the information processing apparatus 100 detects the vehicle (first vehicle) located on the roadside of the road (step S001).

Next, the information processing apparatus 100 starts monitoring the following second vehicle (step S002).

Next, the information processing apparatus 100 calculates a score indicating a degree of possibility for safely overtaking the first vehicle by using the movement and the like of the second vehicle coming from behind the first vehicle (step S003).

Next, the information processing apparatus 100 transmits the calculated score to the control center 200 (step S004).

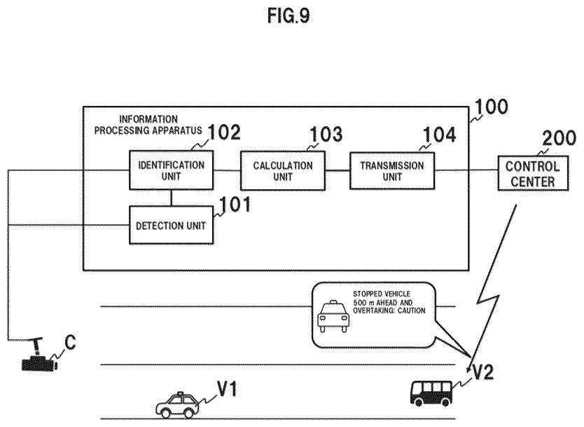

The control center 200 which receives the score creates information to be transmitted to the route bus V2 based on the score, and transmits the information to the route bus V2 (third vehicle) as illustrated in FIG. 9. For example, in the example of FIG. 9, the control center 200 notifies the route bus V2 that there is a stopped vehicle 500 m ahead and that attention should be paid to overtake the stopped vehicle. The driver of the route bus V2 performs driving with reference to such information. For example, in the example of FIG. 9, since it is determined that attention is required for overtaking the vehicle (first vehicle) ahead, the driver of the route bus V2 performs a deceleration operation without overtaking. In this way, it is possible to prevent an accident and the like caused by an unsafe overtaking attempt.

In the above-described example, it has been described that the information processing apparatus 100 transmits the score and the information to the route bus V2 (third vehicle) via the control center 200, but the information processing apparatus 100 may directly transmit the information to the route bus V2 (third vehicle).

### Second Example Embodiment

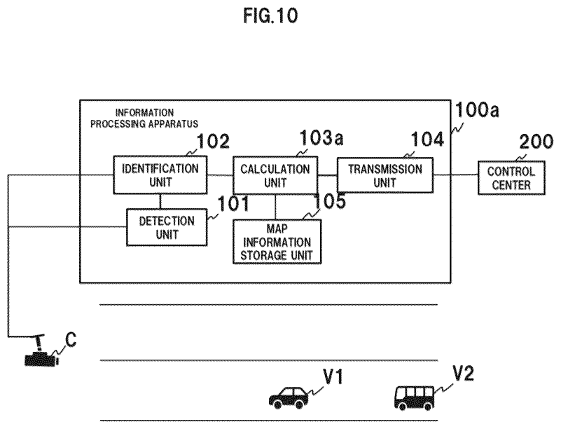

Next, a second example embodiment will be described in which an information processing apparatus calculates a score indicating a degree of possibility for safely overtaking the first vehicle with reference to map information in addition to the image from the camera C. FIG. 10 is a diagram illustrating a configuration of the second example embodiment. The second example embodiment is different from the first example embodiment illustrated in FIG. 6 in that an information processing apparatus 100a includes a map information storage unit 105 and thus the operation of a calculation unit 103a is different. Since other configurations are similar to those of the first example embodiment, the difference between the example embodiments will be mainly described below.

The map information storage unit 105 stores map information for the vicinity of the road. The map information may be, for example, map information used for a route guidance service or road management, but is desirably map information including information regarding nearby facilities. The map information storage unit 105 may be provided outside the information processing apparatus 100a. In this case, the information processing apparatus 100a accesses the external map information storage unit 105 to acquire the map information.

The calculation unit 103a calculates a score indicating a degree of possibility for safely overtaking a first vehicle V1 based on the movement of the second vehicle and the map information. The calculation unit 103a also functions as a map information acquisition means.

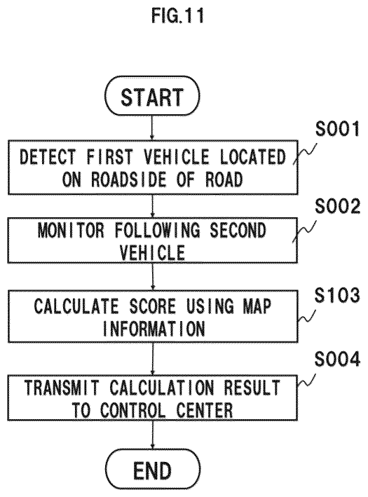

Next, the operation of the present example embodiment will be described in detail with reference to the drawings. FIG. 11 is a flowchart illustrating the operation according to the second example embodiment. The difference from FIG. 8 illustrating the operation according to the first example embodiment is only step S103. Since other steps are similar to those of the first example embodiment, the difference between the steps will be mainly described below.

In step S103, the information processing apparatus 100a calculates a score indicating a degree of possibility for safely overtaking the first vehicle V1 based on the movement of the second vehicle and the map information.

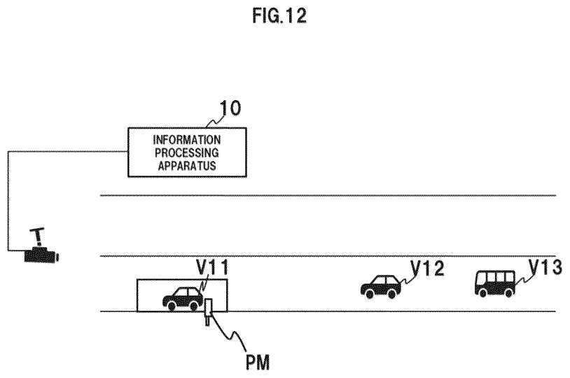

FIGS. 12 to 15 are diagrams illustrating an example in which the information processing apparatus 100a calculates a score using map information. In the example of FIG. 12, the first vehicle V11 is located on the roadside. However, referring to the map information, the position corresponds to the location where a parking meter PM is installed. In this case, the information processing apparatus 100a sets the score indicating a degree of possibility for safely overtaking the first vehicle V11 to a high value regardless of the movement of the second vehicle V12. Not only the parking meter PM but also a store or the like may be present immediately next to the stop position of the first vehicle V11. In this case, similarly, the information processing apparatus 100a sets the score indicating a degree of possibility for safely overtaking the first vehicle V11 to a high value. By using the map information as described above, the calculation accuracy of the score by the information processing apparatus 100a can be improved. By providing the calculated score to the route bus (third vehicle) V13, it is possible to notify the route bus (third vehicle) V13 that there is a high possibility that the first vehicle V11 is a stopped vehicle.

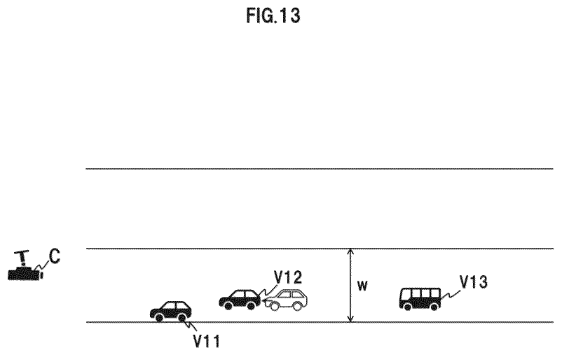

The example of FIG. 13 indicates a state in which the first vehicle V11 is located on the roadside of the road, and the vehicle V12 decelerates and stops in front of the vehicle V11. Referring to the map information, a state is indicated in which it is determined that a width w of the road is wider than the width of a general road. As described above, since the vehicle V12 is stopped although the width w of the road is wide, it is estimated that the starting possibility of the first vehicle V11 is high. For example, it is often the case that the vehicle V11 turns on a blinker but the vehicle V11 is not visible from the route bus (third vehicle) V13 behind. In such a case, since there is a high possibility that the first vehicle V11 will start in the near future, the information processing apparatus 100a sets a score indicating a degree of possibility for safely overtaking the first vehicle V11 to a low value. In this way, by providing the score using the map information to the route bus (third vehicle) V13, it is possible to alert the route bus (third vehicle) V13 in such a way as not to perform unsafe overtaking attempt.

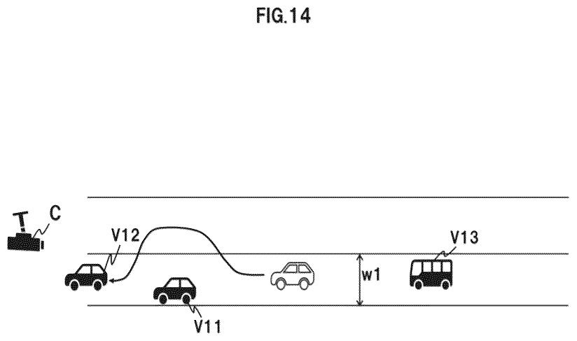

The example of FIG. 14 indicates a state in which the first vehicle V11 is located on the roadside of the road, and the second vehicle V12 overtook the first vehicle V11. Referring to the map information, a state is indicated in which it is determined that a width w1 of the road is narrower than the width of a general road.

As described above, the fact that the second vehicle V12 is overtaking the vehicle V11 even though the width w1 of the road is narrow indicates that the first vehicle V11 shows little indication of starting to move based on its external appearance or no vehicles are coming in the oncoming lane. In this case, the information processing apparatus 100a sets the score indicating a degree of possibility for safely overtaking the first vehicle V11 to a high value. By providing the score using the map information to the route bus (third vehicle) V13, it is possible to inform the route bus (third vehicle) V13 that safe overtaking is possible.

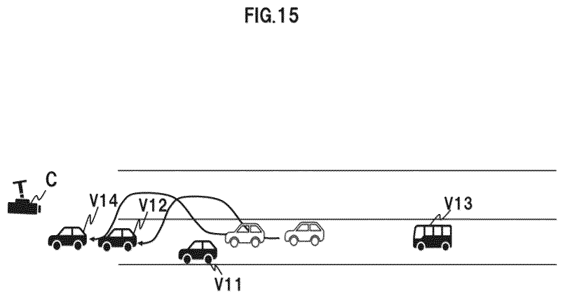

The example of FIG. 15 indicates a state in which the first vehicle V11 is located on the roadside of the road, and a plurality of vehicles V14 and V12 overtake the first vehicle V11. The fact that two following vehicles overtake the first vehicle V11 in succession indicates that the first vehicle V11 shows little indication of starting to move based on its external appearance or no vehicles are coming in the oncoming lane. In this case, the information processing apparatus 100a sets the score indicating a degree of possibility for safely overtaking the first vehicle V11 to a high value. In this way, by providing the score using the map information to the route bus (third vehicle) V13, it is possible to inform the route bus (third vehicle) V13 that safe overtaking is possible.

As described above, according to the present example embodiment, it is possible to calculate the score indicating the degree of possibility for safely overtaking the first vehicle V11 with higher accuracy than in the first example embodiment by using the map information.

### Third Example Embodiment

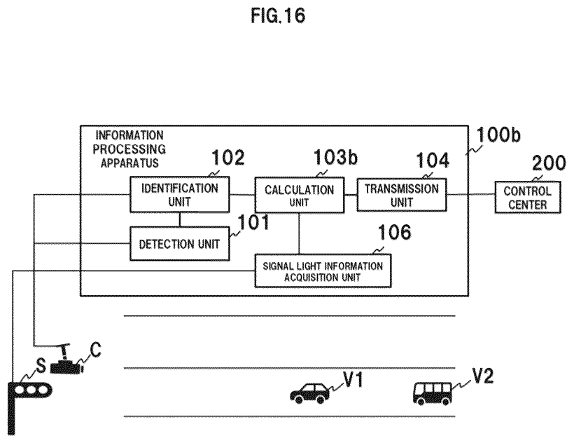

Next, a third example embodiment will be described in which an information processing apparatus calculates a score indicating a degree of possibility for safely overtaking the first vehicle with reference to light information of traffic signals near the road in addition to the image from the camera C. FIG. 16 is a diagram illustrating a configuration of the third example embodiment. The third example embodiment is different from the first example embodiment illustrated in FIG. 6 in that an information processing apparatus 100b includes a signal light information acquisition unit 106 and thus the operation of a calculation unit 103b is different. Since other configurations are similar to those of the first example embodiment, the difference between the example embodiments will be mainly described below.

The signal light information acquisition unit 106 acquires light state information indicating a light state of a traffic light S in front of the first vehicle. In addition to the traffic light S, a signal control device that controls the traffic light S can be considered as an acquisition source of the light state information. In a case where the control center 200 has a function of controlling the traffic light S, the light state information may be acquired from the control center 200.

The calculation unit 103b calculates a score indicating a degree of possibility for safely overtaking the first vehicle V1 based on the movement of the second vehicle and the light state information.

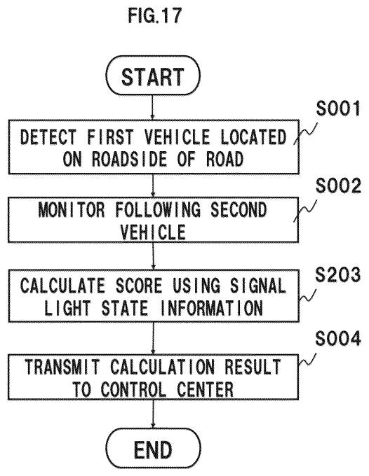

Next, the operation of the present example embodiment will be described in detail with reference to the drawings. FIG. 17 is a flowchart illustrating the operation according to the third example embodiment. The difference from FIG. 8 illustrating the operation according to the first example embodiment is only step S203. Since other steps are similar to those of the first example embodiment, the difference between the steps will be mainly described below.

In step S203, the information processing apparatus 100b calculates a score indicating a degree of possibility for safely overtaking the first vehicle V1 based on the movement of the second vehicle and the light state information.

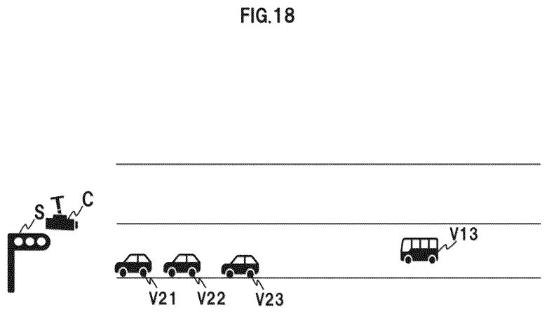

FIG. 18 is a diagram illustrating an example in which the information processing apparatus 100b calculates a score using the light state information. In the example of FIG. 18, a first vehicle V21 is located on the roadside. However, referring to the light state information, the light state of the traffic light S in front of the first vehicle V21 indicates red. In this case, the information processing apparatus 100b sets the score indicating a degree of possibility for safely overtaking the first vehicle V21 to a high value regardless of the movement of a second vehicle V22. The reason is that there is a low possibility that the first vehicle V21 starts to move while the light state of the traffic light S ahead indicates red.

On the other hand, in a case where it is determined based on the content of the light state information that the light state of the traffic light S will change from red to blue, the information processing apparatus 100b sets the score indicating a degree of possibility for safely overtaking the first vehicle V21 to a low value regardless of the movement of the second vehicle V22. The reason is that the first vehicle starts to move when the light state of the traffic light S ahead changes to blue.

As described above, according to the present example embodiment, it is possible to calculate the score indicating the degree of possibility for safely overtaking the first vehicle V21 with higher accuracy than in the first example embodiment by using the light state information. By sending the score, associated images, and the like to the route bus (third vehicle) V13 via the control center 200, it is possible to improve the safety of the operation of the route bus (third vehicle) V13.

Although each of the example embodiments of the present disclosure is described above, the present disclosure is not limited to the above-described example embodiments, and further modifications, substitutions, and adjustments can be made without departing from the basic technical idea of the present disclosure. For example, the network configuration, the configuration of each element, and the representation form of data that are illustrated in the drawings are merely examples that facilitate understanding of the present disclosure, and the present disclosure is not limited to those illustrated in the drawings.

### (Hardware Configuration)

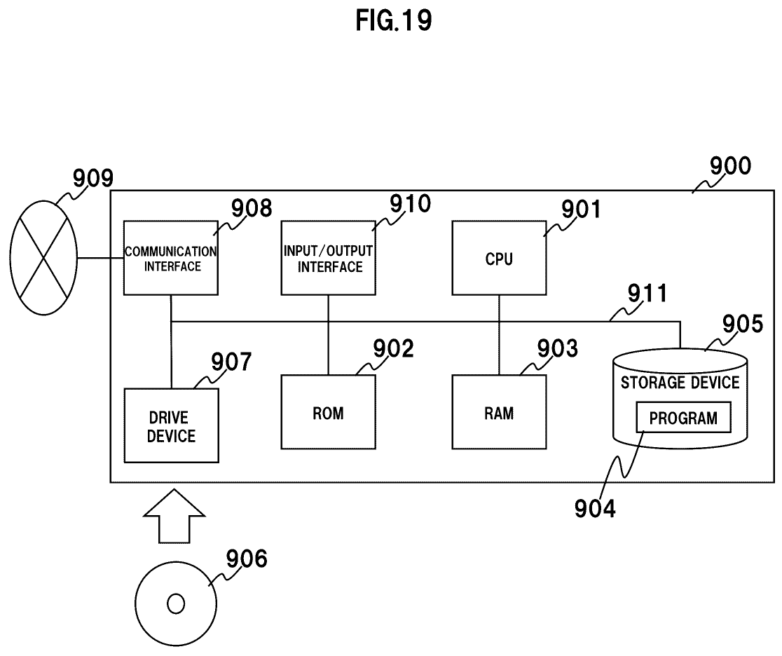

In each of the example embodiments of the present disclosure, each component of the apparatuses indicates a block of a functional unit. A part or all of the components of the apparatuses is achieved by, for example, any combination of an information processing apparatus 900 and a program, as illustrated in FIG. 19. FIG. 19 is a block diagram illustrating an example of a hardware configuration of the information processing apparatus 900 that achieves each component of each apparatus. The information processing apparatus 900 includes the following configuration as an example.
Central processing unit (CPU) 901
Read only memory (ROM) 902
Random access memory (RAM) 903
Program 904 loaded onto RAM 903
Storage device 905 that stores program 904
Drive device 907 that reads from and writes into recording medium 906
Communication interface 908 connected with communication network 909
Input/output interface 910 for inputting/outputting data
Bus 911 connecting between components

The components of the apparatuses in the example embodiments are achieved by the CPU 901 acquiring and executing the program 904 for achieving the functions. That is, the CPU 901 in FIG. 19 may execute a vehicle detecting program and a monitoring program for second vehicle to perform update processing of calculation parameters stored in the RAM 903, the storage device 905, or the like. The program 904 for achieving the functions of the components of the apparatuses is stored in the storage device 905 or the ROM 902 in advance, for example, and is read by the CPU 901 as necessary. The program 904 may be supplied to the CPU 901 via the communication network 909, or may be stored in advance in the recording medium 906 to be read by the drive device 907 and supplied to the CPU 901.

Various modifications exist for the method of achieving the apparatuses. For example, the apparatuses may be achieved by any combination of the information processing apparatus 900 and individual programs for each component. A plurality of components included in the apparatuses may be achieved by any combination of one information processing apparatus 900 and one program. That is, units (processing means and functions) of a information processing apparatus described in the first to third example embodiments may be achieved by a computer program that causes a processor mounted in the apparatus to execute the processing described above by using the hardware.

A part or all of the components of the apparatuses may be achieved by other general-purpose or dedicated circuits, processors, and the like, or a combination thereof. The circuits and the like may be configured by a single chip or may be configured by a plurality of chips connected to each other via a bus.

A part or all of the components of the apparatuses may be achieved by a combination of the above-described circuits and the like and a program.

When a part or all of the components of the apparatuses is achieved by a plurality of information processing apparatuses, circuits, and the like, the plurality of information processing apparatuses, circuits, and the like may be arranged to be centralized or to be distributed. For example, the information processing apparatus, the circuit, and the like may be achieved as a form such as a client and server system or a cloud computing system in which the apparatuses or the like are connected via a communication network.

The above-described example embodiments are preferred example embodiments of the present disclosure, and the scope of the present disclosure is not limited only to the above-described example embodiments. That is, it is possible for those skilled in the art to modify or substitute the above-described example embodiments and construct a mode in which various modifications are made without departing from the gist of the present disclosure.

For example, in the first to third example embodiments described above, the example in which the control center 200 supports the operation of the route bus has been described, but the application range of the present disclosure is not limited thereto. For example, the scores calculated by the information processing apparatuses 100 to 100b can be provided for a specific vehicle or vehicle type. The score indicating a degree of possibility for safely overtaking the first vehicle V11 can also be described in another expression. For example, instead of the score indicating the degree of possibility for safely overtaking the first vehicle V11, a score indicating a high degree of possibility that the first vehicle V11 is a stopped vehicle can be used.

The contents of the table illustrated in FIG. 7 are merely examples, and operations other than those illustrated in FIG. 7 may be identified and applied to the score. For example, when the second vehicle overtakes the first vehicle, in a case where the second vehicle overtakes the first vehicle by maintaining a large lateral distance with the first vehicle, correction may be performed to reduce a score indicating a degree of possibility for safely overtaking the first vehicle. The reason is that in a case where the lateral distance with the first vehicle is large, the driver of the second vehicle may be predicting that the first vehicle will start in the near future. By adjusting the score by increasing or decreasing the score using such various movements of the second vehicle, it is possible to correctly estimate the degree of possibility for safely overtaking the first vehicle.

The second example embodiment and the third example embodiment can be implemented in combination. In this case, the information processing apparatus calculates a score indicating a degree of possibility for safely overtaking the first vehicle based on the movement of the second vehicle, the map information, and the light state information.

A part or all of the above example embodiments may be described as the following Supplementary Notes, but are not limited to the following.

### Supplementary Note 1

An information processing apparatus including:
a detection means for detecting a first vehicle on a road;
an identification means for identifying a movement of a second vehicle coming from behind the first vehicle from an image captured by a camera capable of imaging the road;
a calculation means for calculating a degree of possibility for safely overtaking the first vehicle based on whether the second vehicle has overtaken the first vehicle; and
an output means for outputting information indicating a degree of possibility for safely overtaking the first vehicle to a predetermined output destination.

### Supplementary Note 2

The identification means of the information processing apparatus is capable of being configured to identify the movement of the second vehicle coming from behind the first vehicle from an image captured after the image in which the first vehicle is detected.

### Supplementary Note 3

The output means of the information processing apparatus is capable of being configured to transmit information indicating the degree of possibility for safely overtaking the first vehicle to a third vehicle approaching the first vehicle from behind the first vehicle.

### Supplementary Note 4

The output means of the information processing apparatus is capable of being configured to transmit information indicating the degree of possibility for safely overtaking the first vehicle to a control apparatus that controls a third vehicle approaching the first vehicle from behind the first vehicle.

### Supplementary Note 5

The calculation means of the information processing apparatus is capable of being configured to further calculate the degree of possibility for safely overtaking the first vehicle based on whether a predetermined period of time has elapsed since the first vehicle stopped.

### Supplementary Note 6

The calculation means of the information processing apparatus is capable of being configured to further calculate the degree of possibility for safely overtaking the first vehicle based on whether the second vehicle accelerates while overtaking.

### Supplementary Note 7

The information processing apparatus further includes
a means for acquiring map information for the vicinity of the road, and
the calculation means is capable of being configured to calculate the degree of possibility for safely overtaking the first vehicle based on a movement of the second vehicle and the map information.

### Supplementary Note 8

The information processing apparatus further includes
a means for acquiring light state information indicating a light state of a traffic light in front of the first vehicle, and
the calculation means is capable of being configured to calculate the degree of possibility for safely overtaking the first vehicle based on a movement of the second vehicle and the light state information.

### Supplementary Note 9

The calculation means of the information processing apparatus is capable of being configured to calculate the degree of possibility for safely overtaking the first vehicle based on whether a plurality of vehicles including the second vehicle have overtaken the first vehicle.

### Supplementary Note 10

An information processing method including:
detecting a first vehicle on a road;
identifying a movement of a second vehicle coming from behind the first vehicle from an image captured by a camera capable of imaging the road;
calculating a degree of possibility for safely overtaking the first vehicle based on whether the second vehicle has overtaken the first vehicle; and
outputting information indicating a degree of possibility for safely overtaking the first vehicle to a predetermined output destination.

### Supplementary Note 11

A recording medium that stores a program for executing:
processing of detecting a first vehicle on a road;
processing of identifying a movement of a second vehicle coming from behind the first vehicle from an image captured by a camera capable of imaging the road;
processing of calculating a degree of possibility for safely overtaking the first vehicle based on whether the second vehicle has overtaken the first vehicle; and
processing of outputting information indicating a degree of possibility for safely overtaking the first vehicle to a predetermined output destination.

The modes described in the above-described supplementary notes can be combined with each other after making necessary modifications. For example, a configuration having both the contents described in the Supplementary Note 2 and the contents described in the Supplementary Note 3 is also included in the disclosure range of the present specification.

The modes of the Supplementary Notes 10 and 11 can be expanded to the forms of the Supplementary Notes 2 to 9, similarly to the Supplementary Note 1.

The disclosures of each of the above PTLs is incorporated herein by reference, and may be used as the basis or a part of the present disclosure as necessary. Modifications and adjustments of the example embodiments or examples are possible within the scope of the overall disclosure (including the claims) of present disclosure and based on the basic technical concept of the present disclosure. Various combinations or selections (including partial deletions) of various disclosure elements (including the elements in each of the claims, example embodiments or examples, drawings, and the like) are possible within the scope of the present disclosure. That is, the present disclosure of course includes various variations and modifications that could be made by those skilled in the art in accordance with the technical concept. The description discloses numerical value ranges. However, even if the description does not particularly disclose any numerical values or sub-range included within the ranges, these values and ranges should be construed to have been concretely disclosed. Furthermore, the disclosures of the above-cited documents may be used, in part or in whole, in combination with the descriptions in this document, as part of this disclosure, in accordance with the gist of this disclosure, and such uses are deemed to be included in the disclosures of this application.

### REFERENCE SIGNS LIST

10, 100, 100a, 100b information processing apparatus
11 detection means
12 identification means
13 calculation means
14 output means
101 detection unit
102 identification unit
103 calculation unit
104 transmission unit
105 map information storage unit
106 signal light information acquisition unit
200 control center
900 information processing apparatus
901 central processing unit (CPU)
902 read only memory (ROM)
903 random access memory (RAM)
904 program
905 storage device
906 recording medium
907 drive device
908 communication interface
909 communication network
910 input/output interface
911 bus
C camera
PM parking meter
S traffic lights
V, 1 V11, V12 vehicle
V2, V13 vehicle (route bus)
w, w1 width of the road

What is claimed is:

1. An information processing apparatus comprising:
a memory configured to store instructions; and
a processor configured to execute the instructions to:
detect a first vehicle on a road;
identify a movement of a second vehicle coming from behind the first vehicle from an image captured by a camera capable of imaging the road;
calculate a degree of possibility for safely overtaking the first vehicle based on whether the second vehicle has overtaken the first vehicle; and
output information indicating the degree of possibility for safely overtaking the first vehicle to a predetermined output destination.

2. The information processing apparatus according to claim 1, wherein the processor identifies the movement of the second vehicle coming from behind the first vehicle from an image captured after the image in which the first vehicle is detected.

3. The information processing apparatus according to claim 1,
wherein the processor transmits information indicating the degree of possibility for safely overtaking the first vehicle to a third vehicle approaching the first vehicle from behind the first vehicle.

4. The information processing apparatus according to claim 1,
wherein the processor transmits information indicating the degree of possibility for safely overtaking the first vehicle to a control apparatus that controls a third vehicle approaching the first vehicle from behind the first vehicle.

5. The information processing apparatus according to claim 1,
wherein the processor further calculates the degree of possibility for safely overtaking the first vehicle based on whether a predetermined period of time has elapsed since the first vehicle stopped.

6. The information processing apparatus according to claim 1,
wherein the processor further calculates the degree of possibility for safely overtaking the first vehicle based on whether the second vehicle accelerates while overtaking.

7. The information processing apparatus according to claim 1,
wherein the processor acquires map information for the vicinity of the road vicinity and
calculates the degree of possibility for safely overtaking the first vehicle based on a movement of the second vehicle and the map information.

8. The information processing apparatus according to claim 1,
wherein the processor acquiring light state information indicating a light state of a traffic light in front of the first vehicle and
calculation means calculates the degree of possibility for safely overtaking the first vehicle based on a movement of the second vehicle and the light state information.

9. The information processing apparatus according to claim 1,
wherein the processor calculates the degree of possibility for safely overtaking the first vehicle based on whether a plurality of vehicles including the second vehicle have overtaken the first vehicle.

10. An information processing method comprising:
detecting a first vehicle on a road;
identifying a movement of a second vehicle coming from behind the first vehicle from an image captured by a camera capable of imaging the road;
calculating a degree of possibility for safely overtaking the first vehicle based on whether the second vehicle has overtaken the first vehicle; and
outputting information indicating a degree of possibility for safely overtaking the first vehicle to a predetermined output destination.

11. A non-transitory recording medium that stores a program for causing a computer to execute processing comprising
detecting a first vehicle on a road;
of identifying a movement of a second vehicle coming from behind the first vehicle from an image captured by a camera capable of imaging the road;
calculating a degree of possibility for safely overtaking the first vehicle based on whether the second vehicle has overtaken the first vehicle; and
outputting information indicating a degree of possibility for safely overtaking the first vehicle to a predetermined output destination.

12. The information processing apparatus according to claim 2,
wherein the processor transmits information indicating the degree of possibility for safely overtaking the first vehicle to a third vehicle approaching the first vehicle from behind the first vehicle.

13. The information processing apparatus according to claim 2,
wherein the processor transmits information indicating the degree of possibility for safely overtaking the first vehicle to a control apparatus that controls a third vehicle approaching the first vehicle from behind the first vehicle.

14. The information processing apparatus according to claim 3,
wherein the processor transmits information indicating the degree of possibility for safely overtaking the first vehicle to a control apparatus that controls a third vehicle approaching the first vehicle from behind the first vehicle.

15. The information processing apparatus according to claim 2,
wherein the processor further calculates the degree of possibility for safely overtaking the first vehicle based on whether a predetermined period of time has elapsed since the first vehicle stopped.

16. The information processing apparatus according to claim 3,
wherein the processor further calculates the degree of possibility for safely overtaking the first vehicle based on whether a predetermined period of time has elapsed since the first vehicle stopped.

17. The information processing apparatus according to claim 4,
wherein the processor further calculates the degree of possibility for safely overtaking the first vehicle based on whether a predetermined period of time has elapsed since the first vehicle stopped.

18. The information processing apparatus according to claim 2,
wherein the processor further calculates the degree of possibility for safely overtaking the first vehicle based on whether the second vehicle accelerates while overtaking.

19. The information processing apparatus according to claim 3,
wherein the processor further calculates the degree of possibility for safely overtaking the first vehicle based on whether the second vehicle accelerates while overtaking.

20. The information processing apparatus according to claim 4,
wherein the processor further calculates the degree of possibility for safely overtaking the first vehicle based on whether the second vehicle accelerates while overtaking.
